(19) United States
(12) Patent Application Publication
(10) Pub. No.: US 2025/0229199 A1
(43) Pub. Date: Jul. 17, 2025

(54) SIMULATED MOVING BED LITHIUM CHROMATOGRAPHIC SEPARATION PROCESS

(71) Applicant: SEPROSYS, LA ROCHELLE (FR)

(72) Inventors: Stanislas BAUDOUIN, PERIGNY (FR); Delphine DUFOUR, PERIGNY (FR)

(21) Appl. No.: 19/018,170

(22) Filed: Jan. 13, 2025

(30) Foreign Application Priority Data
Jan. 17, 2024 (FR) FR2400471

(51) Int. Cl. B01D 15/18; C22B 3/24; C22B 26/12

(52) U.S. Cl. CPC B01D 15/1842; B01D 15/1835; B01D 15/185; C22B 3/24; C22B 26/12

(57) ABSTRACT

The present invention relates to a process for the chromatographic separation of lithium contained in a simulated moving bed brine, said a process comprising a step of fractioning the brine into at least two distinct streams, each of the brine streams being charged into each injection point of a simulated moving bed chromatography (SMB), then percolated, finally the lithium is recovered by means of at least two extraction points.

### CROSS-REFERENCE TO RELATED APPLICATIONS

this application claims the benefit of priority from French patent application FR 2400471 having the filing date of Jan. 17, 2024, the entire disclosure of which is herein incorporated by reference in its entirety.

### TECHNICAL FIELD

The invention concerns a new process for the chromatographic separation of lithium contained in a brine by simulated moving bed, said process making it possible to significantly improve the operation of a simulated moving bed by obtaining optimum lithium separation with high productivity, while limiting eluent consumption. The process according to the present invention comprises in particular a step of loading the lithium contained in a brine into at least two injection points of a simulated moving bed chromatography (SMB), said brine being previously divided into at least two distinct streams and each stream injected into at least two injection/loading points, followed by a step of recovering the lithium from at least two extraction points.

### BACKGROUND

Over the past 20 years, lithium has become a key resource in the energy transition, and thanks to its low molar mass and small size, it is the ideal metal for designing rechargeable batteries. Lithium is extracted either from lithiniferous rocks or from brines. There are several types of brine that can be used for lithium extraction: salt brines, geothermal brines and hydrocarbon brines.

Many processes for recovering lithium from brines are already known. The classic process is mainly based on the variation of salt solubility as a function of concentration. Thus, brine is evaporated naturally in lagoons, and Sodium Chloride (NaCl) crystallizes until Sodium is at the solubility limit, while Magnesium and Calcium are crystallized by the addition of lime and carbonate.

However, this process is time-consuming, requires large quantities of reagent and dries out the extraction sites, which are already water-stressed zones. What's more, a substantial proportion of the lithium precipitates out during the various crystallization stages, resulting in a low yield of around 50%.

To overcome these drawbacks, lithium-specific adsorbents have been developed. They are based on microporous crystalline structures. Examples include patent FR 3053264, which describes the production of a synthetic mineral adsorbent based on aluminum oxide, and patent application US2020010926, which describes a synthetic hybrid adsorbent coupling an anionic resin and a crystalline aluminum oxide deposit. Other titanium-based adsorbents as described in patent application WO2023083065 can also be used.

Some of these materials can be synthesized by precipitating aluminum sulfate, sodium aluminate and at least one lithium source in an aqueous medium. The presence of lithium during precipitation defines the specific pore size for lithium capture. However, these materials require a minimum lithium content in the medium, in particular to avoid collapse of their crystalline structure, leading to loss of lithium capture capacity. Thanks to these different adsorbents, it is now possible to extract lithium directly from brines by chromatographic separation.

Typically, brine is percolated over the adsorbent of interest, then the adsorbent is rinsed and desorbed with a lithium-poor solution. The lithium-rich fraction is recovered and goes through the successive stages until lithium salt is produced.

Various technical solutions have already been described, including a chromatographic separation process comprising a single column which is loaded and then unloaded by successively carrying out the steps of saturation, rinsing and displacement of the lithium-loaded solution.

Other processes have been developed to improve the productivity and efficiency of adsorbents. One example is the 3-column carousel process, which uses a system of circular permutation of 3 adsorbent beds: 2 columns are placed in series and percolated with the solution containing the lithium to be captured, so that the first column reaches capture saturation when the second column captures the leakage from the first. A third column is being rinsed and the lithium displaced. After saturation, the first column replaces the third column, which is then rinsed and the lithium is displaced by the wash solution The column in second position moves to first position, and the column after washing replaces the column previously in second position.

In addition to these co-current capture and release processes, the person skilled in the art has developed processes based on the principle of backwashing.

Thus, Broughton et al. (U.S. Pat. No. 2,985,589) proposed the principle of the simulated moving bed (SMB). This system enables countercurrent chromatography by simulating the movement of the solid phase contained in a multitude of columns connected in series by a set of valves that will move the solvent injection and extraction points in a regular, sequenced manner. The solvent and adsorbent move in opposite directions, maximizing the separation effect between adsorbed and non-adsorbed molecules.

Several developments have been proposed to improve the simulated moving bed principle, including the SSMB process described by Yoritomi et al. (U.S. Pat. No. 4,379,751) which, by splitting the SMB step into independent sub-steps, improves injection and fraction collection accuracy. Tanimura et al. (JP 119784/88) proposes ISMB, an intermediate process between SMB and SSMB. We can also cite Bailly et al. (FR2785196), which proposes asynchronous permutation of inputs and outputs, enabling variable column distribution over time (VARICOL).

Finally, this principle of chromatographic separation by simulated moving bed has already been proposed for lithium extraction and separation (Martson et al. U.S. Pat. No. 11,365,128) describing an SMB carousel with 30 columns distributed over 4 zones.

However, the disadvantage of all these teachings is low productivity, given the presence of a single adsorption zone and a single desorption zone. However, in the context of the energy transition and the growing need for Lithium, these processes are unsatisfactory from an ecological and environmental point of view, as well as in terms of productivity.

There is therefore a need for a chromatographic separation process with improved productivity that overcomes the drawbacks of the prior art. This is the purpose of the present invention.

### SUMMARY OF THE INVENTION

Thus, the present invention relates to an improved process for the chromatographic separation of lithium contained in a brine by simulated moving bed, wherein a continuous chromatography comprises a multitude of columns connected in series and a multitude of valves arranged so as to isolate and/or permute said columns forming at least four zones,
a zone 1 comprising at least two contiguous columns, an eluent injection point and at least two extract extraction points for an extract comprising separated lithium, said zone 1 being located between the eluent injection point and the second extract extraction point 2 located downstream of the first extract extraction point 1,
a zone 2 between the second extract extraction point 2 and a brine injection point,
a zone 3 comprising at least two contiguous columns, at least two brine injection points and at least two raffinate extraction points, said zone 3 being comprised between the first brine injection point and the second raffinate extraction point, located downstream of the first brine injection point, itself located downstream of the first raffinate extraction point, and
a zone 4 comprised between the second raffinate extraction point and the eluent injection point,
wherein said process comprises the following steps:
a. Split the brine into at least two separate streams, a brine stream 1 and a brine stream 2,
b. Inject brine stream 1 at the first brine injection point in zone 3 and inject brine stream 2 at the second brine injection point in zone 3,
c. Percolate said streams into said contiguous columns in zone 3 and charge the eluent at the eluent injection point,
d. Recover and dispose of each raffinate stream at each raffinate extraction point, and
e. Recover separated lithium at each extract extraction point.

Thus, unlike the prior art, which teaches us the injection/charging of a single brine stream, the present invention, by splitting the initial stream into as many brine streams of interest (n brine streams), preferentially at least two distinct streams, and injecting these into at least two injection points, makes it possible to improve the productivity of lithium separation from brine. Indeed, this maximizes the flow rate of treated brine in relation to the number of columns, while retaining the advantages of the simulated moving bed principle.

Thus, brine is injected at at least two injection points, then circulates cyclically and sequentially through a continuous countercurrent adsorption and desorption circuit, and extracts comprising separated lithium are recovered at at least two extraction points for said extracts, located in zone 1. A first extraction point recovers a diluted lithium extract 1, and a second extraction point, located downstream of the first extraction point, recovers a concentrated lithium extract 2.

To achieve this, zone 3 is advantageously divided into at least two sub-zones (zone 3.1 and zone 3.2), each comprising an inlet (brine stream loading point) and an outlet (raffinate extraction point). Thus, for the purposes of the invention, zone 3 comprises at least two sub-zones. According to one variant, zone 3 comprises up to 4 sub-zones.

Zone 1 is divided into at least two sub-zones (zone 1.1 and zone 1.2), each with at least one outlet (extract extraction point). Thus, for the purposes of the invention, zone 1 also comprises at least two sub-zones.

According to a variant of the invention, a sub-zone can be interpreted as a zone. Also, in this context, chromatography according to the present invention can comprise at least 4+y zones, with y≥(greater than or equal to) 2, preferentially y is between 2 and 6, each zone comprising a column, and comprising an inlet and an outlet. When chromatography comprises 6 zones, it includes zone 1.1, zone 1.2, zone 2, zone 3.1, zone 3.2 and zone 4.

When brine is split into two separate streams, the ratio between the volume of brine stream 1 injected and brine stream 2 injected is preferentially between 1/99 and 50/50, more preferentially between 20/80 and 50/50.

According to a further object of the present invention, chromatography zone 3 can comprise n contiguous columns connected to each other in series or operating in parallel.

According to a preferred object of the process according to the invention, zone 3 comprises n contiguous columns, each column comprising a brine stream injection point and a raffinate extraction point, wherein the process comprises a step wherein the brine is fractionated into n distinct streams and each stream is injected into each of the injection points of zone 3, n being between 3 and 5.

According to another particular embodiment of the invention, zone 3 comprises at least three contiguous columns, two contiguous columns in series comprising a single brine stream injection point and a single raffinate extraction point, and a third contiguous column also comprising a brine injection point and a raffinate extraction point.

Advantageously, zone 3 comprises three contiguous columns comprising three brine-stream injection points and three raffinate extraction points, wherein the process comprises a step wherein the brine is fractionated into 3 separate streams and injected into each of the injection points of zone 3. In this embodiment, zone 3 comprises three inlets for loading each of the brine streams and three outlets for disposing of the raffinate.

The process according to the present invention therefore comprises a brine injection or loading step, said brine being fractionated into n distinct streams, preferentially at least two distinct streams and injected independently of each other into n injection points, preferentially at least two injection points located in zone 3. When injecting each stream, each brine stream is preferentially injected simultaneously or sequentially.

More preferentially, the step of loading the said streams is carried out simultaneously, again making it possible to improve productivity by increasing flow rate. However, the start of loading of one stream may differ from the start of loading of the second stream, as may the end of loading of said streams.

According to another embodiment of the process according to the invention, the process can also include a step of placing the multitude of columns forming the chromatography in series, enabling the steady-state chromatographic profile to be shifted to the downstream column in SSMB and ISMB chromatography. Particularly advantageous is the closed-loop serial connection of the multitude of columns forming the chromatography, which notably enables the steady-state chromatographic profile to be shifted to the downstream column in SSMB and ISMB chromatography.

In addition, the process according to the invention advantageously comprises a step of recovering a diluted lithium extract 1 at the extract extraction point located furthest downstream of zone 1, followed by a step of injecting said diluted lithium extract at the eluent injection point in order to maintain a minimum lithium concentration in the eluent.

Finally, the process according to the invention can also include an additional step of placing the multitude of columns forming the chromatography in series and rinsing said columns.

According to another object of the invention, the step of recovering each of the lithium extracts, namely a diluted lithium extract 1 and a concentrated lithium extract 2, is carried out simultaneously or separately. Preferentially, the step of recovering said extracts is carried out simultaneously, again to improve productivity. However, the recovery of each of the streams is very preferentially simultaneous, during which the start and end of recovery of the diluted extract and the concentrated extract may differ.

The process according to the invention can be implemented with any type of brine, however, the brine is preferentially chosen from the group consisting of Salt brines, geothermal brines and petroleum brines.

The process according to the present invention is particularly well suited to known simulated moving bed (SMB) chromatographic separation processes, as well as its variants known as SSMB, ISMB, VARICOL. By injecting/charging at least a second brine stream, the process according to the present invention maximizes the input flow rate and thus the productivity of the process for separating lithium from brines.

Preferentially, the process according to the invention is a simulated moving bed (SMB) chromatographic separation process, wherein the number of columns forming the chromatography is at least 6, more preferentially at least 8.

Finally, any type of adsorbent known to the person skilled in the art can be used to implement the process according to the invention. Examples include, but are not limited to, titanium-based adsorbents.

Other features and advantages will emerge from the detailed description of the invention, examples and figures that follows.

### BRIEF DESCRIPTION OF THE FIGURES

FIG. 1 schematically represents the process according to the present invention implemented with chromatography according to the simulated moving bed principle, said chromatography comprising 6 columns, forming 4 zones, (Z1, Z2, Z3, and Z4), zone 3 comprising two contiguous columns, two brine injection points (feed) and two raffinate extraction points (raffinate 1 and raffinate 2), zone 1 comprising two contiguous columns, one eluent injection point and two extraction points for an extract containing separated lithium (extract 1 and extract 2). At the end of each stage, the columns are swapped by one downstream column (6 positions). The process is run continuously. This chromatography thus presents 6 successive positions before a complete revolution of the sequence.

FIG. 2 schematically represents the process according to the present invention implemented with chromatography according to the simulated moving bed principle, said chromatography comprising 7 columns, forming 4 zones, (Z1, Z2, Z3, and Z4), zone 3 comprising three contiguous columns, two of which are connected in series, two brine injection points (feed 1, feed 2) and two raffinate extraction points (raffinate 1 and raffinate 2), zone 1 comprising two contiguous columns, one eluent injection point and two extraction points for an extract comprising separated lithium (extract 1 and extract 2). At the end of each stage, the columns are swapped by one downstream column (7 positions). The process is run continuously. Said chromatography thus presents 7 successive positions before a complete revolution of the sequence.

FIG. 3 schematically represents the process according to the present invention implemented with chromatography according to the simulated moving bed principle, said chromatography comprising 7 columns, forming 4 zones, (Z1, Z2, Z3, and Z4), zone 3 comprising three contiguous columns, three brine injection points (feed 1, feed 2, and feed 3) and three raffinate extraction points (raffinate 1, raffinate 2, and raffinate 3), zone 1 comprising two contiguous columns, one eluent injection point and two extraction points for an extract comprising separated lithium (extract 1 and extract 2). At the end of each stage, the columns are swapped by one downstream column (7 positions). The process is run continuously. Said chromatography thus presents 7 successive positions before a complete revolution of the sequence.

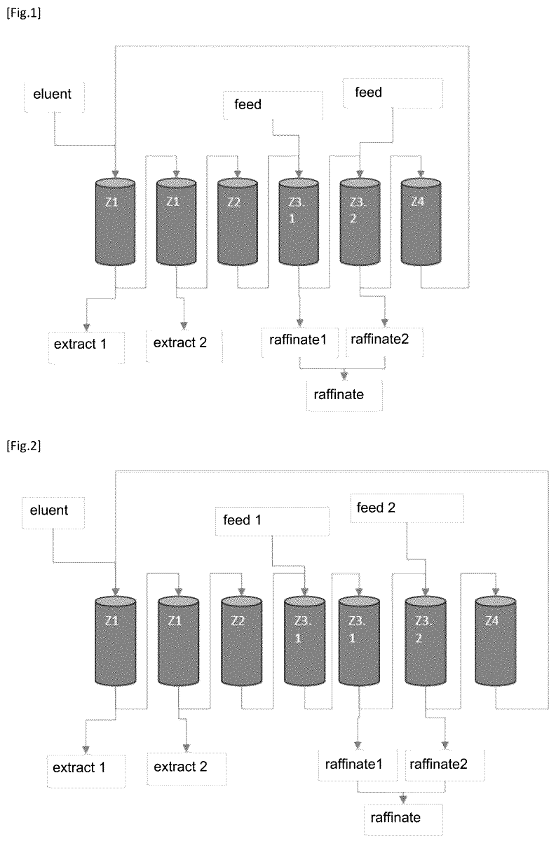

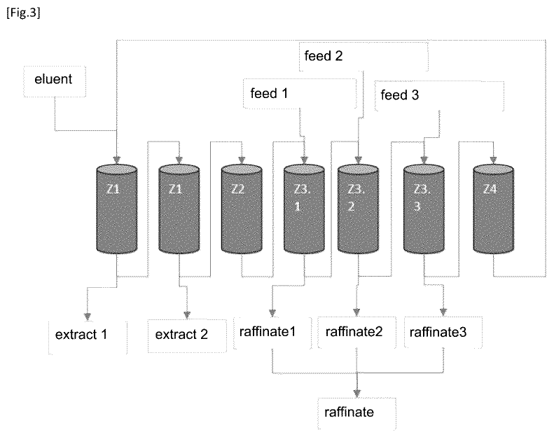

### DETAILED DESCRIPTION OF THE INVENTION

### Definition

By “series” in the sense of the invention, we mean two contiguous columns linked together, wherein the most upstream column comprises an injection point, for example a brine stream injection point, and the most downstream column comprises a raffinate extraction point.

By “parallel” in the sense of the invention, we mean two contiguous columns, wherein each column comprises an injection point, for example a brine stream injection point, and a raffinate extraction point.

### Process

The object of the present invention is therefore an improved process for simulated moving bed chromatographic separation of lithium contained in a brine solution.

Said simulated continuous moving bed chromatography comprises a multitude of columns connected in series and a multitude of valves arranged to isolate and/or permute said columns forming four zones. Chromatography thus comprises a zone 1 between an eluent injection point and an extract extraction point, a zone 2 between an extract extraction point and a brine injection point, a zone 3 between a brine injection point and a raffinate extraction point, and a zone 4 between a raffinate extraction point and an eluent injection point.

The extract extraction point corresponds to the outlet of zone 1, enabling recovery of the extract comprising lithium separated from the other molecules contained in a brine.

The brine injection point or brine loading point is the inlet through which the brine stream is loaded into the chromatograph.

The raffinate extraction point is the exit point for raffinate recovery. This does not contain lithium, and is considered as waste and therefore disposed of.

However, the inventors found that it was possible to significantly improve the operation of a simulated moving bed by achieving optimum lithium separation with high productivity, while limiting eluent consumption. To achieve this, the inventors have added a second inlet in zone 3, enabling the chromatograph to be loaded with a second brine stream. This second brine stream is then loaded into a second injection point in zone 3. In addition, at least one second lithium extract extraction point is added in zone 1.

To this end, the inventors have developed a process wherein the brine stream is previously split into at least two brine streams, each of the streams being injected into at least two injection points in zone 3. As a result, at least two raffinate extraction points are added downstream of each of the brine stream injection points.

In addition, a second extraction point for lithium-containing extract is added downstream of zone 1. Zone 1 comprises an eluent injection point located upstream of an extraction point for recovering and collecting a diluted lithium extract 1, itself upstream of an extraction point for recovering and collecting a concentrated lithium extract 2.

The said diluted lithium extract 1 can advantageously be reinjected in whole or in part into the eluent. This is then reinjected at the eluent injection point. Alternatively, the diluted lithium extract 1 can be mixed with a solvent before being reinjected into the eluent.

Thus, in the context of the present invention, zone 1 of simulated moving bed chromatography comprises at least two contiguous columns, an eluent injection point and at least two extract extraction points for extract comprising separated lithium, said zone being comprised between the eluent injection point and the second extract extraction point located downstream of the first extract extraction point.

According to a particular embodiment, zone 1 comprises at least two contiguous columns, each respectively forming a zone 1.1 between the eluent injection point and an extract 1 extraction point, corresponding to the diluted lithium extract, and a zone 1.2 between the extract 1 extraction point and an extract 2 extraction point, corresponding to the concentrated lithium extract.

In addition, simulated moving bed chromatography also includes a zone 3 comprising at least two contiguous columns, at least two brine injection points and at least two raffinate extraction points, said zone 3 being comprised between the first brine injection point and the second raffinate extraction point, located downstream of the first brine injection point, itself located upstream of the first raffinate extraction point.

According to a particular embodiment, zone 3 comprises at least two contiguous columns, each respectively forming at least one zone 3.1 between a brine stream injection point 1 and a raffinate extraction point, and at least one zone 3.2 between a brine stream injection point 2, said brine stream injection point 2 being located downstream of the raffinate extraction point 1, and a raffinate extraction point 2.

The process according to the present invention then comprises the following steps:
a. Split the brine into at least two separate streams, a brine stream 1 and a brine stream 2,
b. Inject brine stream 1 at the first zone 3 brine injection point and inject brine stream 2 at the second zone 3 brine injection point,
c. Percolate said streams into said contiguous columns in zone 3 and charge the eluent at the eluent injection point,
d. Recover and dispose of each raffinate stream at each raffinate extraction point, and
e. Recover separated Lithium at each extract extraction point.

Thus, the present invention relates to a process for the chromatographic separation of lithium contained in a brine by simulated moving bed, wherein a continuous chromatography comprises a multitude of columns connected in series and a multitude of valves arranged so as to isolate and/or permute said columns forming four zones,
a zone 1 comprising at least two contiguous columns, an eluent injection point and at least two extraction points for an extract comprising separated lithium, said zone being located between the eluent injection point and the second extraction point of the extract downstream of the first extraction point of the extract,
a zone 2 comprised between the second extract extraction point and a brine injection point,
a zone 3 comprising at least two contiguous columns, at least two brine injection points and at least two raffinate extraction points, said zone 3 being comprised between the first brine injection point and the second raffinate extraction point, located downstream of the first brine injection point, itself located upstream of the first raffinate extraction point, and
a zone 4 comprised between the second raffinate extraction point and the eluent injection point,
said process comprises the following steps:
a. Split the brine into at least two separate streams, a brine stream 1 and a brine stream 2,
b. Inject brine stream 1 at the first zone 3 brine injection point and inject brine stream 2 at the second zone 3 brine injection point,
c. Percolate said streams into said contiguous columns in zone 3 and charge the eluent at the eluent injection point,
d. Recover and dispose of each raffinate stream at each raffinate extraction point, and
e. Recover separated Lithium at each extract extraction point.

The process according to the invention thus advantageously maximizes the flow rate of treated brine in relation to the number of columns, while retaining the advantages of the simulated moving bed principle.

According to an object of the invention, simulated moving bed chromatography can comprise, in zone 3, n contiguous columns, which can be connected to each other in series, or operating in parallel. When the n contiguous columns operate in parallel, they each include an upstream brine injection point and a downstream raffinate extraction point.

Thus, according to a preferred object, said moving bed chromatography thus comprises n inlets allowing the injection of n brine streams, thus maximizing productivity. Thus, zone 3 preferentially comprises n contiguous columns, each column comprising a brine stream injection point and a raffinate extraction point, wherein the process comprises a step wherein the brine is fractionated into n distinct streams and each stream is injected into each of the injection points of zone 3, n being between 3 and 5.

When the n contiguous columns are connected in series, the set of n contiguous columns connected in series comprises a single upstream injection point for a brine stream and a single downstream raffinate extraction point. According to a particular object, zone 3 can thus comprise n contiguous columns connected in series and at least one additional contiguous column operating in parallel. Zone 3 thus comprises a brine stream injection point and, downstream, a raffinate extraction point, and at least one other brine stream injection point and, downstream, at least one other raffinate extraction point.

According to a particular object of the present invention, the simulated moving bed chromatography may comprise a third contiguous column in zone 3. Zone 3 thus comprises at least three contiguous columns, two contiguous columns in series comprising a brine stream injection point and a raffinate extraction point, and at least a third contiguous column comprising a brine injection point and a raffinate extraction point. The third contiguous column comprising a second brine stream injection point and a raffinate extraction point is located downstream of said two contiguous columns in series. Zone 3 thus comprises three contiguous columns, two injection points and two extraction points. According to another object, zone 3 comprises four contiguous columns, three injection points and three extraction points.

According to anther object of the invention, the simulated moving bed chromatography may comprise a third contiguous column in zone 3, forming a zone 3.3 comprising a third injection point for a third brine stream, and a third raffinate extraction point.

Advantageously, zone 3 comprises at least three contiguous columns comprising three brine stream injection points and three raffinate extraction points, wherein the brine is fractionated into at least three separate streams and injected into each of the injection points in zone 3, thereby improving both productivity and yield. Zone 3 thus comprises three contiguous columns, three injection points and three extraction points.

By way of example, the process according to the invention is a simulated moving bed (SMB) chromatographic separation process, wherein the number of columns forming the chromatography is at least 6, with two columns forming a zone 1, one column forming a zone 2, two columns forming a brine loading/injection zone 3 and one column forming a zone 4.

According to another particular example, the number of columns forming the chromatography is at least 7, with loading zone 3 comprising 3 contiguous columns, operating in parallel and/or connected in series, and lithium recovery zone 1 comprising 2 contiguous columns.

When the brine is fractionated into two separate streams, the ratio between the volume of the injected brine stream 1 and the injected brine stream 2 is preferentially between 1/99 and 50/50, more preferentially between 20/80 and 50/50, further improving the productivity of the separation process.

When brine is split into three separate streams, the ratio between the volume of brine stream 1 injected, brine stream 2 injected, and brine stream 3 injected is preferentially between Jan. 1, 1998 and 1/3:1/3:1/3, more preferentially between Oct. 10, 1980 and 1/3:1/3:1/3.

When brine is split into n separate streams, the ratio between the volume of each injected brine stream is very preferentially 1/n.

According to an object of the invention, the brine stream injection steps 1 and 2 are preferentially carried out simultaneously or sequentially, very preferentially simultaneously to improve productivity by increasing flow rate. However, the start and end of loading for each stream may differ.

According to a particular embodiment, the process comprises a step of recovering a diluted lithium extract 1 from the extract extraction point located furthest downstream of zone 1, and injecting said diluted lithium extract at the eluent injection point. Advantageously, all or part of said diluted lithium extract is reinjected into the eluent. This is then reinjected at the eluent injection point. According to one variant, the diluted lithium extract can be mixed with a solvent before being reinjected into the eluent.

Preferentially, the recovery of each of the lithium extracts, that is, at least the diluted lithium extract and the concentrated lithium extract, can be carried out simultaneously or separately, preferentially simultaneously.

Finally, the process according to the invention can include an additional step of placing the multitude of columns forming the chromatography in series and rinsing said columns.

According to a particular embodiment of the invention, particularly when the chromatography is of the SSMB or ISMB type, the process advantageously comprises a step of placing the multitude of columns forming the chromatography in series, which enables the steady-state chromatographic profile to be shifted to the downstream column.

The process according to the invention can be implemented with any type of brine known to contain lithium, preferentially selected from the group consisting of salt brines, geothermal brines and petroleum brines.

The invention is now shown by non-limiting examples of compositions according to the invention and by results.

### Examples

### Example 1: Non-Inventional Process

### Adsorption-Desorption of a Synthetic Li Na Brine on a Single Column

This test is carried out using a process comprising a single column which is loaded and then unloaded by successively carrying out the steps of saturation, rinsing and displacement of the lithium-loaded solution (brine).

The process according to example 1 comprises the following steps:
a. Step 1: The brine is charged until the adsorbent is saturated.
b. Step 2: eluent is injected to displace the impregnation brine and elute adsorbed lithium.

The effluent is then advantageously separated into 3 distinct parts, namely a Sodium-rich part 1, a Lithium-rich part 2, and a part 3 comprising diluted lithium. The column characteristics are described in table 1, below.

TABLE 1

| Column length | | Column diameter | | Column volume | | temperature | |
|---|---|---|---|---|---|---|---|
| 100 | cm | 2.5 | cm | 490 | mL | 80° | C. |
| Li brine | | NA | | Saturation | | Elution | |
| | | | | flow rate | | flow rate | |
| 0.5 | g/L | 92 | g/L | 5 | BV/h | 2 | BV/h |

The following results are based on a dimensional volumes, that is, 1 BV=1 column volume.

The results are presented in tables 2 to 3 below.

TABLE 2

| | | | Bm |
|---|---|---|---|
| mg/liter resin | saturation | elution | elution |
| Li input | 8029 | 1054 | |
| li output | 3989 | 5055 | |
| Li fixed | 4039 | 4001 | 99% |
| Capture % | 50% | | |

TABLE 3

| | | | Bm |
|---|---|---|---|
| g/liter resin | saturation | elution | elution |
| Na input | 1392389 | 0 | |
| Na output | 1277287 | 74820 | |
| Na fixed/eluted | 115101 | 74820 | 65% |
| Capture % | 8% | | |

The inventors observe that 50% of the lithium is captured once it has been completely eluted. In addition, 8% of sodium is captured, with elution of only 65% of Na.

The inventors then assessed the results of the trial. The results are presented in table 4 below.

TABLE 4

| | medium 0 to 1 BV | | medium 1 to 2 BV | | medium 2 to 6 BV | |
|---|---|---|---|---|---|---|
| | concen- | recovery | concen- | recovery | Concen- | recovery |
| | tration | % | tration | % | tration | % |
| | mg/L | on output | mg/L | on output | mg/L | on output |
| Li | 1277 | 25.9% | 1815 | 36.9% | 458 | 55.8% |
| NA | 73120 | 97.7% | 1700 | 2.2% | 840 | 1.1% |

| | | | |
|---|---|---|---|
| Na/Li | 57.27 | 0.94 | 1.83 |

From the analysis of the elution profile, the inventors have cut out 3 zones corresponding to the lithium peak:
From 0 to 1 BV, the inventors found that 25.9% of lithium was captured and 97.7% of sodium
From 1 to 2 BV, the inventors note that the Lithium peak represents 36.9% of the eluted lithium and 2.3% of the eluted sodium
From 2 to 6 BV, the inventors observed a high lithium trail, representing 55.8% of eluted lithium, and a low sodium concentration, representing 1.1% of eluted sodium.

With this test, only 22.6% of the committed lithium and 0.1% of the sodium are recovered. The purification effect is good, but the recovery yield is low. The amount of lithium purified is 0.56 g of lithium per liter per hour.

### Example 2: Non-Inventional Process

### Adsorption-Desorption of a Synthetic Li Na Brine on a 3-Column Carousel

The 3-column carousel process is based on circular permutation of 3 adsorbent beds: 2 columns are placed in series and percolated with the solution containing the lithium to be captured, so that the first column reaches capture saturation when the second column captures the leakage from the first. A third column is being rinsed and the lithium displaced. After saturation, the first column replaces the third column, which is then rinsed and the lithium is displaced by the wash solution The column in second position moves to first position, and the column after washing replaces the column previously in second position.

The process comprises the following steps:
a. Stage 1: brine loading, extraction of spent brine (raffinate) on columns 1 and 2 in series
b. Stage 2: eluent loading on columns 1 and 2 in series, rinsing of column 1, recovery of spent brine from column 2
c. Step 3: recovery of the impregnation volume from the column containing the end of the sodium peak
d. Step 4: recovery of the lithium peak core
e. Step 5: recovery of the lithium peak tail.

Once the 5 stages have been completed, the entry and exit points are shifted one column downstream. The column in 1^{st} position becomes column 3. The 2^{nd} position column becomes column 1. The column in 3^{rd} position becomes column 2. This cycle repeats itself ad infinitum.

Lastly, the feed from step 3 can be recycled as feed, while the feed from step 4 is the lithium-enriched product. Finally, the collection from step 5 corresponds to the diluted lithium that will be used to prepare the eluent.

The characteristics are presented in Table 5 below.

TABLE 5

| Column length | | Column diameter | | Column volume | | temperature | |
|---|---|---|---|---|---|---|---|
| 100 | cm | 2.5 | cm | 490 | mL | 80° | C. |
| Li brine | | NA | | Saturation | | Elution | |
| | | | | flow rate | | flow rate | |
| 0.5 | g/L | 92 | g/L | 5 | BV/h | 2 | BV/h |

In this test, the inventors used 3 columns of identical dimensions to that of example 1, implemented on the process described previously.

The characteristics of the process are presented in table 6 below.

TABLE 6

| | | Volume | time | Flow rate |
|---|---|---|---|---|
| STEPS | | (BV) | (s) | (BV/h) |
| 1 | loading column 1 in series | 5.15 | 3158 | 5.87 |
| | with column 2 with brine | | | |
| 2 | wash column 1 in series | 0.40 | 257 | 5.87 |
| | with column 2 with eluent | | | |
| 3 | elution of column 3 with | 0.70 | 840 | 3 |
| | eluent | | | |
| 4 | elution of column 3 with | 1.60 | 1920 | 3 |
| | eluent | | | |
| 5 | elution of column 3 with | 1.10 | 660 | 6 |
| | eluent | | | |

The characteristics of the composition of inputs and outputs are described in table 7, below.

TABLE 7

| | inputs (g/L) | | | outputs (g/L) | | |
|---|---|---|---|---|---|---|
| STEPS | Li (mp) | Na | Cl | Li (mp) | Na | Cl |
| 1 | 0.511 | 93.645 | 147.93 | 0.058 | 80.561 | 127.20 |
| 2 | 0.156 | 0.040 | 0.890 | 0.452 | 90.421 | 141.98 |
| 3 | 0.16 | 0.04 | 0.89 | 0.630 | 51.373 | 83.42 |
| 4 | 0.16 | 0.04 | 0.89 | 1.024 | 1.074 | 7.04 |
| 5 | 0.16 | 0.04 | 0.89 | 0.609 | 0.116 | 3.07 |

The results are presented in table 8 below.

TABLE 8

| ASSESSMENTS | Li | Na | Cl | Na/Li |
|---|---|---|---|---|
| % I/O | 100% | 99% | 97% | |

% recovery in outputs

| | | | | |
|---|---|---|---|---|
| 3 | 16.0% | 95.1% | 80.0% | 81.544 |
| 4 | 59.6% | 4.5% | 15.4% | 1.049 |
| 5 | 24.4% | 0.3% | 4.6% | 0.190 |

This test yields 59.6% of lithium in pure fraction 4, compared with 36.9% for the single-column solution. This increases the system's productivity: the amount of lithium recovered is 1.17 g/liter of resin per hour. Fraction 5 is used to prepare the eluent for the next injection. Fraction 3 is recycled into the brine to be treated.

### Example 3: Non-Inventional Process

### Adsorption-Desorption of a Synthetic Li Na Brine on a 6-Column SSMB

This test is carried out using the SSMB principle, with 6 columns of identical dimensions to example 1.

Like the 3-column carousel, the SSMB principle has a cyclic sequence, with the following stages:
a. Stage 1: internal column volume recycling loop stage
b. Stage 2: brine loading stage on two contiguous columns in zone 3 in series, with raffinate recovery at column outlet; parallel injection of eluent into column 1 and recovery of lithium fraction at column 2 outlet.
c. Stage 3: eluent injection stage for rinsing from column 1 to column 5 in series, recovery of the remaining raffinate.

At the end of the stage, the entry and exit points are shifted one column upstream. This operation continues indefinitely.

The characteristics are presented in table 9 below.

TABLE 9

| Column length | | Column diameter | | Column volume | | temperature | |
|---|---|---|---|---|---|---|---|
| 100 | cm | 2.5 | cm | 490 | mL | 80° | C. |
| Li brine | | Na | | Saturation | | Elution | |
| | | | | flow rate | | flow rate | |
| 0.5 | g/L | 92 | g/L | 10 | BV/h | 3 | BV/h |

The characteristics of the process used are described in table 10 below.

TABLE 10

| | | Volume | time | Flow rate |
|---|---|---|---|---|
| STEPS | | (BV) | (s) | (BV/h) |
| 1 | Loop stage | 0.75 | 276 | 9.78 |
| 2 | Brine feed stage | 5.30 | 1951 | 9.78 |
| 3 | Extract extraction stage | 2.4 | 1951 | 4.42 |
| 4 | Rinsing stage for zones 1 | 0.25 | 92 | 9.78 |
| | to 3 | | | |

The characteristics of the composition of inputs and outputs are described in table 11, below.

TABLE 11

| | |
|---|---|
| inputs (g/L) | outputs (g/L) |

| STEPS | Li | Na | Li | Na |
|---|---|---|---|---|
| 2 | 0.487 | 91.84 | 0.150 | 90.47 |
| 3 | 0.17 | 0.0 | 1.123 | 0.236 |
| 4 | 0.17 | 0.0 | 0.150 | 90.47 |

The results are presented in table 12 below.

TABLE 12

| ASSESSMENTS | Li | Na | Na/Li |
|---|---|---|---|
| % I/O | 103% | 103% | |

% recovery in outputs

| | | | |
|---|---|---|---|
| 2 + 4/RAFFINATE | 26% | 99.9% | 624 |
| 3/EXTRACT | 74% | 0.1% | 0.210 |

With SSMB implementation, it is possible to obtain a very pure lithium fraction, the Na/Li is now 0.191. Extraction yield is 74%, with 26% of the lithium remaining in the brine due to incomplete desorption. The eluent volume is only 1.95 BV, while the carousel volume is 3.8 BV. The amount of lithium recovered is 0.46 g/liter of resin per hour, that is, ⅓ compared to the carousel. SSMB is interesting for purity, but has low yields and low productivity.

### Example 4: Process According to the Invention

### Adsorption-Desorption of a Synthetic Li Na Brine on an 8-Column SSMB.

This test is carried out according to the process of the present invention, comprising 8 columns of identical dimensions to example 1, with zone 1 comprising 3 contiguous columns and zone 3 comprising three contiguous columns, including two columns in series, two loading points and two raffinate outlets.

The characteristics of the column are presented in table 13 below.

TABLE 13

| Column length | | Column diameter | | Column volume | | temperature | |
|---|---|---|---|---|---|---|---|
| 100 | cm | 2.5 | cm | 490 | mL | 80° | C. |
| Li brine | | Na | | Saturation | | Elution | |
| | | | | flow rate | | flow rate | |
| 0.5 | g/L | 92 | g/L | 3-6 | BV/h | 2-6 | BV/h |

The characteristics of the process are presented in table 14 below.

TABLE 14

| | | Volume | time | Flow rate |
|---|---|---|---|---|
| STEPS | | (BV) | (s) | (BV/h) |
| 1 | Loop stage | 0.65 | 390 | 6 |
| 2.1 | Brine feed stage 1 | 3.7 | 2200 | 6 |
| 2.2 | Brine feed stage 2 | 2.1 | 2200 | 3.40 |
| 3.1 | Extract 1 extraction step | 1.30 | 1680 | 2.11 |
| 3.2 | Extract 2 extraction step | 0.70 | 420 | 6 |
| 4 | Rinsing stage for zones 1 | 0.25 | 92 | 6 |
| | to 3 | | | |

The characteristics of the composition of inputs and outputs are described in table 15, below.

TABLE 15

| | |
|---|---|
| inputs (g/L) | outputs (g/L) |

| STEPS | Li | Na | Li | Na |
|---|---|---|---|---|
| 2 | 0.510 | 91.70 | 0.052 | 89.70 |
| 3 | 0.15 | 0.0 | 2.100 | 0.110 |
| 4 | 0.15 | 0.0 | 0.052 | 89.70 |

The results are presented in table 16 below.

TABLE 16

| ASSESSMENTS | Li | Na | Na/Li |
|---|---|---|---|
| % I/O | 102% | 102% | |

% recovery in outputs

| | | | |
|---|---|---|---|
| 2 + 4/Raffinate | 9.3% | 99.96% | 1725 |
| 3.1/extract Li | 81.1% | 0.04% | 0.05 |
| 3.2 extracts for | 9.6% | 0.01% | 0.217 |
| eluent | | | |

The inventors have found that using the process according to the invention, it is possible to obtain a very pure lithium fraction, with the Na/Li now at 0.05. The extraction yield is 81.1%, with 9.3% of the lithium lost in the brine, giving an output recovery (excluding recycled extract) of 89.7%.

The amount of lithium recovered is 0.81 g/liter of resin per hour, that is, ⅔ compared to the carousel. The process according to the present invention not only improves purity, but also enhances lithium recovery through better extraction, and is more productive than SSMB due to parallel brine injections.

The process according to the invention overcomes the disadvantages of the prior art and in particular offers higher yields, productivity close to that of a 3-column carousel system thanks to 2 parallel injections, minimal eluent consumption and maximum recovery thanks to 2 parallel eluent injections.

Finally, table 17 below compares the results obtained with the various tests.

TABLE 17

| Process | Example 1 | Example 2 | Example 3 | Example 4 |
|---|---|---|---|---|
| Minimum columns | 1 | 3 and up | 4 and up | 6 and up |
| Number of | 1 | 3 | 6 | 8 |
| colonies | | | | |
| Na/Li extract | 0.94 | 1.049 | 0.191 | 0.05 |
| purity | | | | |
| Productivity | 0.56 | 1.17 | 0.46 | 0.81 |
| gLi/liter | | | | |
| adsorbent. H-1 | | | | |
| % recovery | 36.9 | 59.6 | 74.0 | 89.7 |
| Eluent | 3.74 | 2.21 | 0.98 | 0.82 |
| consumption | | | | |
| liter/g lithium | | | | |
| recovered | | | | |

The results demonstrate an improvement in productivity compared with known simulated moving bed processes, as well as an improvement in the recovery and purity levels obtained.

We claim:

1. A process for chromatographic separation of lithium contained in brine by simulated moving bed, wherein a continuous chromatography comprises a multitude of columns connected in series and a multitude of valves arranged to isolate and/or permute said columns forming at least four zones,
a zone 1 comprising at least two contiguous columns, an eluent injection point and at least two extract extraction points for an extract comprising separated lithium, said zone being located between the eluent injection point and the second extract extraction point downstream of the first extract extraction point,
a zone 2 comprised between the second extract extraction point and a brine injection point,
a zone 3 comprising at least two contiguous columns, at least two brine injection points and at least two raffinate extraction points, said zone 3 being comprised between the first brine injection point and the second raffinate extraction point, located downstream of the first brine injection point, itself located upstream of the first raffinate extraction point, and
a zone 4 comprised between the second raffinate extraction point and the eluent injection point,
characterized in that said process comprises the following steps:
a. Split the brine into at least two separate streams, a brine stream 1 and a brine stream 2,
b. Inject brine stream 1 at the first brine injection point in zone 3 and inject brine stream 2 at the second brine injection point in zone 3,
c. Percolate said streams into said contiguous columns in zone 3 and charge the eluent at the eluent injection point,
d. Recover and dispose of each raffinate stream at each raffinate extraction point, and
e. Recover separated Lithium at each extract extraction point.

2. The process according to claim 1, characterized in that zone 3 comprises at least three contiguous columns, two contiguous columns in series comprising a brine injection point and a raffinate extraction point, and at least a third contiguous column comprising a brine injection point and a raffinate extraction point.

3. The process according to claim 1, wherein zone 3 comprises n contiguous columns, each column comprising a brine stream injection point and a raffinate extraction point, characterized in that the brine is fractionated into n distinct streams and each stream is injected into each of the injection points of zone 3, n being between 3 and 5.

4. The process according to claim 1, characterized in that the ratio between the volume of the injected brine stream 1 and the injected brine stream 2 is between 1/99 and 50/50.

5. The process according to claim 1, characterized in that the ratio is comprised between 20/80 and 50/50.

6. The process according to claim 1, characterized in that the injection of each brine stream is carried out simultaneously or sequentially.

7. The process according to claim 1, characterized in that the process also comprises a closed-loop serialization step of the multitude of columns forming the chromatography.

8. The process according to claim 1, characterized in that the process comprises a step of recovering a diluted lithium extract 1 at the extract extraction point located furthest downstream of zone 1 and injecting said diluted lithium extract at the eluent injection point.

9. The process according to claim 1, characterized in that the process comprises an additional step of placing the multitude of columns forming the chromatography in series and rinsing said columns.

10. The process according to claim 1, characterized in that the step of recovering each of the lithium extracts, at least one dilute lithium extract and at least one concentrated lithium extract, is carried out simultaneously or separately.
